(19) United States
(12) Patent Application Publication
(10) Pub. No.: US 2024/0257630 A1
(43) Pub. Date: Aug. 1, 2024

(54) CONFIGURING CAUSE AND EFFECT MATRICES USING ALARM SYSTEM EVENT DETECTION DEVICES

(71) Applicant: Honeywell International Inc., Charlotte, NC (US)

(72) Inventors: Murali R, Hosur (IN); Prakash Sivalingam, Bangalore (IN)

(21) Appl. No.: 18/103,669

(22) Filed: Jan. 31, 2023

(51) Int. Cl. G08B 25/00; G08B 25/10

(52) U.S. Cl. CPC G08B 25/008; G08B 25/10

(57) ABSTRACT

Systems, methods, and processes of configuring cause and effect matrices using alarm system event detection devices in an area within a facility are described herein. One method, includes initiating a zone configuration software by sending computing device executable instructions to a control panel of an alarm system, sending, via the control panel, instructions, to each event detection device of the alarm system, to initiate short range communication to detection devices within each device's communication range, receiving detection device identification information that identifies each detection device within a particular device's communication range, and determining and creating a zone by clustering detection devices with a communication signal strength above a threshold strength value.

### TECHNICAL FIELD

The present disclosure relates to systems, methods, and processes of configuring cause and effect matrices using alarm system event detection devices in an area within a facility.

### BACKGROUND

Facilities equipped with alarm systems allow for early detection of an emergency event, such as a fire or presence of a harmful chemical situation occurring. This allows for emergency personnel to arrive more quickly.

The systems utilize sensing devices (e.g., fire detectors, smoke detectors, chemical sensors, hand pull devices, etc.) spread throughout the facility that can detect when an event may be occurring. These alarm system devices communicate sensor information to an on premise alarm system control panel that collects and analyzes the data to determine whether an emergency event is occurring, and contacts emergency personnel to come to the facility to deal with the event.

Typically, such facilities are large and can be complex (e.g., large building, multiple floors, facilities with multiple buildings). Thus, it may be difficult for commissioning personnel, when setting up the system to keep track of all of the system devices that are to be used in the system and to configure them correctly.

In some situations, a map, for example, from a building information model (BIM), can be generated and used by commissioning personnel, but it may be incomplete, not up to date, or incorrect and does not aid in keeping track of all system devices.

### BRIEF DESCRIPTION OF THE DRAWINGS

FIG. 1 is an example of an event alarm system in accordance with one or more embodiments of the present disclosure.

FIG. 2 is another example of an event alarm system in accordance with one or more embodiments of the present disclosure.

FIG. 3 is a commissioning flow example of an event alarm system in accordance with one or more embodiments of the present disclosure.

FIG. 4 is an example of an event alarm system having multiple alarm system event detection devices having communication components organized in areas of a facility and communicating to establish one or more zones in accordance with one or more embodiments of the present disclosure.

FIG. 5 is an example of a system input and output device grouping structure of an event alarm system in accordance with one or more embodiments of the present disclosure.

### DETAILED DESCRIPTION

Cause and Effect (C&E) rules play a vital role in event alarm systems. C&E rules provide the process of mapping, initiating sensors, and notification appliances to interoperate to identify particular events and provide correspondingly appropriate particular notifications to users of the alarm system, occupants of the facility, system monitoring personnel, emergency personnel, facility ownership, and/or system maintenance personnel based on the particular type of event identified. Activating appropriate audible and/or visual notifications, initiating voice alarm notifications, playing evacuation and/or alert messages on a user's computing device at a right time and/or in the right places are important factors to life safety at a facility.

Currently, during commissioning of an alarm system control panel at the facility, the commissioning engineer references a floor plan and/or as-built drawings to create Cause & Effect rule based logic. However, the drawings may not be updated to the latest modifications that the facility has gone through. In retrofit job sites, the commissioning engineer must manually add, to the alarm system software, a newly added physical detector device to an existing C&E zone (area of the building where a set of C&E rules applies), and this needs a specialized and oftentimes proprietary configuration tool. This also requires a software license to the tool and such a manual addition is a time-consuming process.

In other instances, a control panel central processing unit (CPU) is the process engine where most of the alarm system critical decisions, like alarm triggering, output activations, event transmission to remote stations, etc., are carried out. When a signaling line circuit (SLC) card (interface circuitry between detector devices and a control panel) loses its transmission and/or reception communication (Tx-Rx) with the control panel CPU, all the critical decisions processes cannot be accomplished and, thereby, no C&E rules can be initiated and put into effect. The occupants of the facility, remote stations, and/or monitoring centers will not receive an indication of an event that has occurred in the facility (except fault indicator signals indicating the communication issue being present at the one or more remote stations).

Further, in current systems, mapping appropriate inputs and/or outputs for causes and effects is a manual process and time-consuming activity even when a configuration tool is used. The manual process of mapping C&E can cause a risk of missing an input device, especially in large sites like airports, multistory buildings, casinos, hotels, shopping malls, warehouses, etc. Updating C&E based on recent changes that occur is tedious and a continuous process for technicians. Additionally, C&E activation during a CPU communication loss state puts the occupants and facility at risk as the notification application circuits (NACs) (circuits that actuate notification components such as fire horns, bells, strobes, chimes, and/or speakers, etc.) may not activate.

Systems, methods, and processes of configuring cause and effect matrices using alarm system event detection devices in an area within a facility are described herein. For example, one method, includes initiating a zone configuration software by sending computing device executable instructions to a control panel of an alarm system, sending, via the control panel, instructions, to each event detection device of the alarm system, to initiate short range communication to detection devices within each device's communication range, receiving detection device identification information that identifies each detection device within a particular device's communication range, and determining and creating a zone by clustering detection devices with a communication signal strength above a threshold strength value. The embodiments of the present disclosure provide mechanisms in a building safety system to use event detectors with built-in communication components to configure cause and effect matrices.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

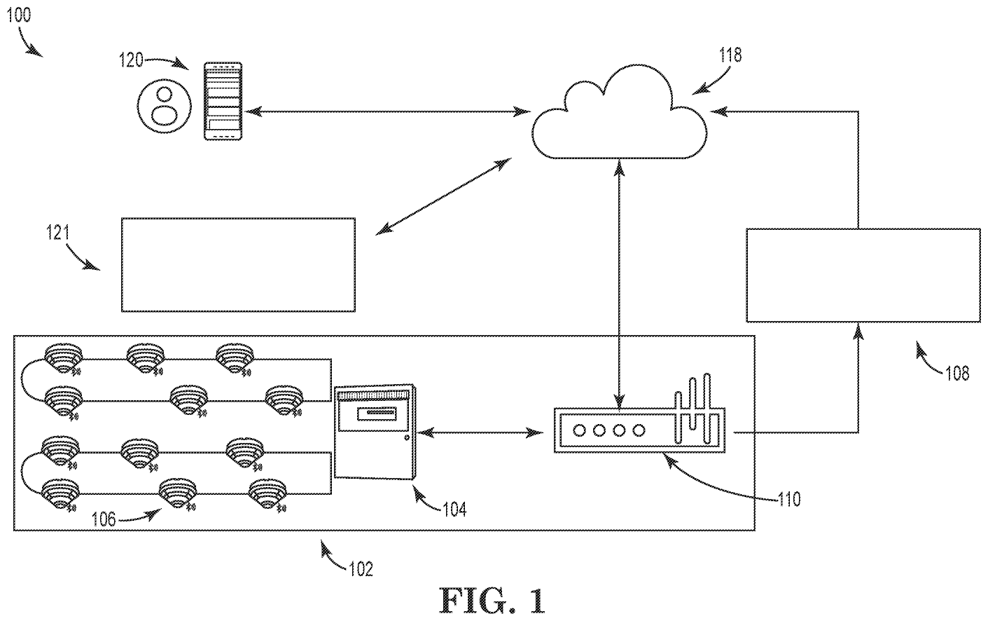

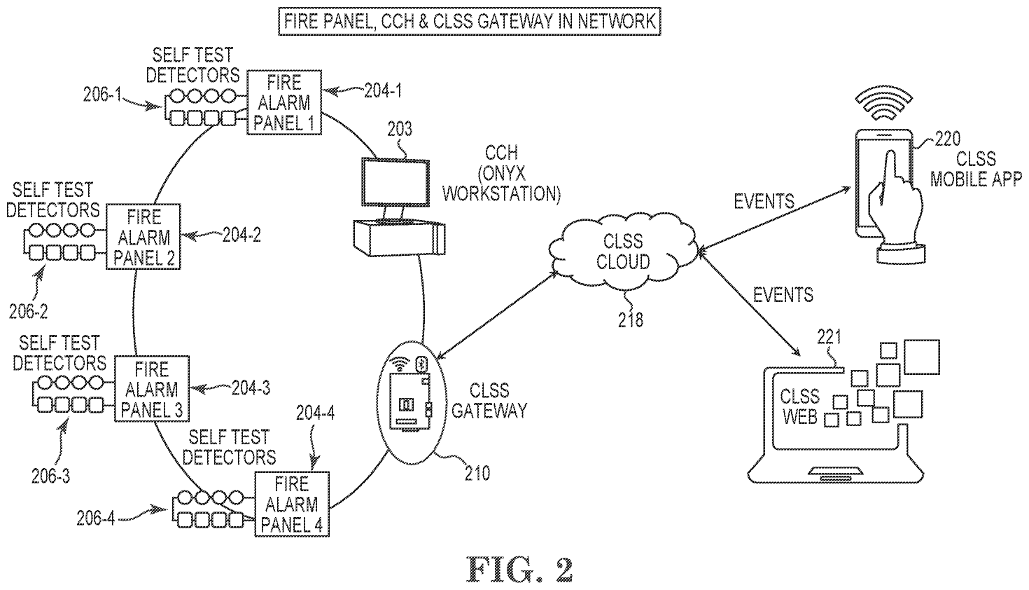

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 206 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of a building safety event notification system for use in accordance with one or more embodiments of the present disclosure. In the illustrated embodiment, the building safety event notification system 100 includes an alarm system 102, a central monitoring station having at least one computing device 108, a remote server (e.g., cloud server) 118, a portable device 120, and one or more building owner/operator/emergency personnel communication application devices 121.

An event alarm signal is generated in response to data from one or more alarm system event detection devices 106 (e.g., smoke detectors) within the alarm system 102 indicating that an event (e.g., fire, emergency situation) may be occurring. As used herein, the term “event” may refer to any condition occurring within the building, such as a fire, smoke, or chemical sensor activation, an alarm trigger (pull station), or a breach of security.

It may also be referred to as a fault detected in any of the components of the system 100, such as a fault in one or more of the alarm system event detection devices 106. The central monitoring station 108 may be staffed by employees of the provider of the alarm system 102, and they may not know specific details of each building they are monitoring, but rather, are charged with alerting appropriate emergency event response personnel (e.g., fire fighters) based on the particular type of response needed and coordinating the particular response to the building to address the particular type of event that is occurring at the building.

The alarm system 102 can be any system that is used to monitor events that will affect occupants of the building. As shown in FIG. 1, the alarm system illustrated is a fire alarm system and includes a number of alarm system event detection devices 106 having transmission and reception of communication mechanisms to send and/or receive instructions and/or data and a control panel 104 for managing the operation of the alarm system 102 and its devices.

As used herein, the term “control panel” refers to a device at the facility to control components of an alarm system of a facility (e.g., building). For example, the control panel 104 can be a fire control panel that can receive information from event detection devices (e.g., fire detectors, smoke detectors, chemical detectors) 106 and determine whether an emergency event (e.g., a fire) is occurring or has occurred.

The control panel may be configured to transmit information about the emergency event to the computing device 108 and to the cloud 118. This information, may include, for example, a unique identifier of the event detection device 106 which detected the event, a date and/or time of the event, a status of the event (e.g., resolved, unresolved), and/or an event type (e.g., smoke detected, communication fault).

The control panel 104 is connected to the number of alarm system event detection devices 106 to send instructions to and/or receive data from devices 106. As used herein, the term “alarm system event detection device” refers to a device that can send data regarding an event occurring in the device's coverage area (where it can sense an event occurring) and/or receive an input relating to an event. Such alarm system event detection devices 106 can be a part of an alarm system of the facility and can include devices such as fire sensors, smoke detectors, heat detectors, carbon monoxide (CO) detectors, an other chemical detector, or combinations of these; interfaces; pull stations; input/output modules; aspirating units; and/or audio/visual devices, such as speakers, sounders, buzzers, microphones, cameras, video displays, video screens, and other detector devices, among other types of alarm system devices.

These alarm system event detection devices 106 can be automatic, self-test devices, such as smoke detectors, heat detectors, CO detectors, other chemical detectors, and/or others. Such self-test devices can include mechanisms that generate aerosols, heat, carbon monoxide, etc. and sense these items, as appropriate to the type of device being tested in the device, to test the performance of the device. This can, for example, be to test the event detection device's thermal, chemical, and/or photo sensing capabilities. Such a test can be initiated automatically, for example via instructions from the control panel software and/or initiated with user input, for example, through a portable device, remote device, or control panel and communicated to the detection device via transmitter, receiver, and/or transceiver components within the self-test detection device.

The alarm system event detection devices 106 utilized in the embodiments of the present disclosure each include communication components (e.g., transmitters, receivers, transceivers) that allow them to directly, or via another device of the system, communicate with a portable device 121, carried by a technician or emergency responder, for example. This collaboration between the portable device 121 and the system event detection devices 106, allow for the enhanced zone defining functions described herein.

The alarm system 102 can also include an edge/gateway device 110. The gateway device 110 acts as a pass-through device for communicating between the alarm system 102 at the facility and the central monitoring station 108 and other components of the event notification system 100 that are at remote locations (i.e., outside the facility).

A gateway device 110 of an alarm system 102 at a facility (e.g., building) can, for example, report event alarm signals to one or more central monitoring servers. These servers may be on premises (within the facility) or, as shown in the example of FIG. 1, off premises (at a remote location from the alarm system components including the event detection devices 106, the gateway device 110, and the control panel 104).

From there, the event alarm signals can, for example, be reported to the appropriate central monitoring station. This is done through the computing device 108. For example, information about event alarm signals may be displayed on a graphical user interface of a remote or local application on the computing device 108.

The central monitoring station includes administrator personnel that, as discussed above, coordinate activities to respond appropriately based on the type of event that is occurring. For example, a fire event would need a fire-based response that would likely include alerting a fire station to send trucks and, potentially, contacting medical personnel, if injuries seem likely. The information provided could include the type of fire so that emergency responders know whether they will need water or foam to put the fire out.

For a security issue, security personnel and/or the police would be contacted. For an issue relating to the operation of an alarm system device 106, a technician would be contacted and directed to the location of the faulty alarm system event detection device 106. The central monitoring servers are connected back to one or more alarm systems on site and/or remote (cloud) servers, such as alarm system 102 and remote server 118.

Event alarm signals can also be transmitted to the remote server 118. These signals may include, for example, the time and date of the event, a network name, a unique identifier of the event detection device(s) 106 which detected the event, an event type, or an event status.

The remote server 118 may transmit this information to authorized users through portable device 121. For example, device 121 may be a mobile application accessible through a portable device, such as a mobile, phone, tablet, or laptop computing device.

In some current implementations, this information is represented only textually. Although a very experienced user who knows the building incredibly well may be able to decipher the location of the event based on information provided, such as the unique event detection device identification number, most users will not be able to determine the exact location within a floor of the event through text representation on device 121 alone.

Floorplans of each floor of the building may be accessible through the computing device 108. For example, such floorplans may be stored in the memory of the computing device 108. These building floorplans may be configured to include specific locations of all of the alarm system event detection devices 106. These floorplans may be accessed, and portions of the plans may be transferred to device 121 to enable the creation of a visual floor representation as described herein.

FIG. 2 is another example of an event alarm system having multiple alarm system event detection device groups (206-1, 206-2, 206-3, 206-4) connected to multiple fire panels (204-1, 204-2, 204-3, 204-4). The devices 206 being organized in areas of a facility and communicating with a portable device 220 in accordance with one or more embodiments of the present disclosure. When an event detection device 206 detects an event in one of these multiple subsystems, the control panel 204 can report the event detection to all end points (e.g., devices 210, 221, 220, 203, and 208).

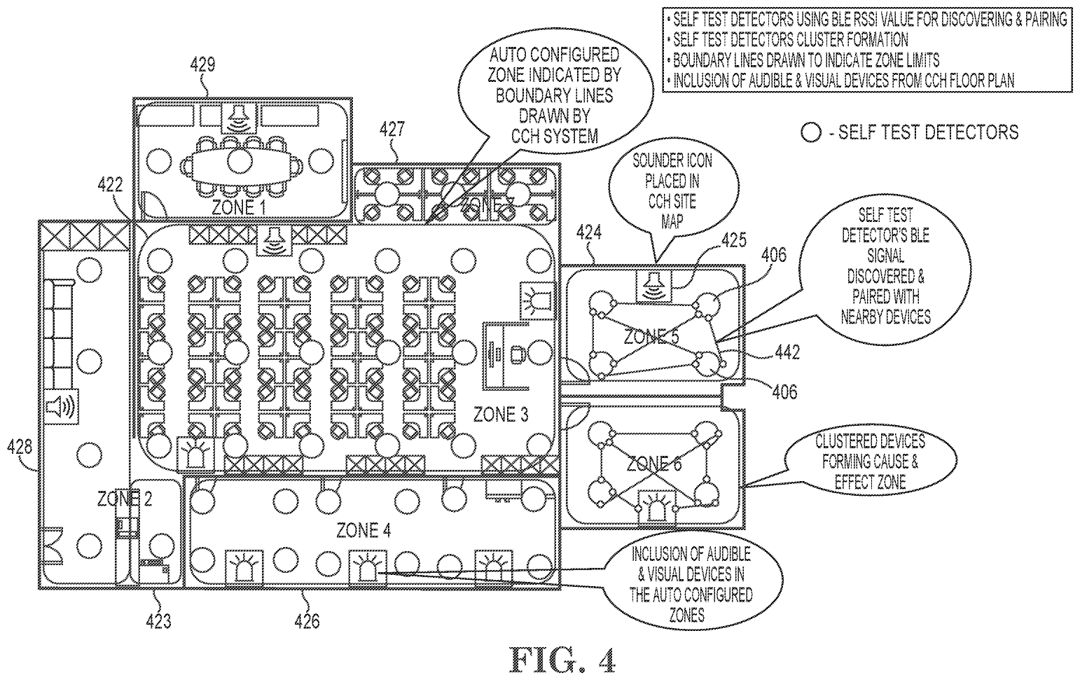

One or more of these devices can reference data stored in memory and can create a visual display of the location of the event on a facility layout (e.g., layout illustrated in FIG. 4) of the visual floor representation. For example, as discussed above, a building floorplan can be accessed that contains the location of each event detection device 206 within the building. These locations can, for example, be entered into memory and/or onto the floorplan 201 (e.g., a jpg format file or other suitable visual file format) during a commissioning of the alarm system process, wherein the system is set up and made operational.

During commissioning, the commissioning technician can determine physical locations for each of the event detection devices on a floor and position device indicators, for example, by dragging and dropping an indicator for each of the event detection devices 206 to the location on the floorplan that corresponds to the physical location of each event detection device (e.g., shown as circles 406 representing physical locations of each device in FIG. 4), thereby creating a map of the physical location of each device in the area shown on the map. For instance, during commissioning on a computing device 203 that is networked to the alarm system (devices 206 and panels 204), the technician can pull up the floorplan for building #1, floor #4 and the technician will verify that each event detection device is correctly located on the floorplan (i.e., its location on the floorplan correctly corresponds to its physical location on floor #4) thereby creating the visual floor representation. The technician can then use the information about these devices 206 and their physical locations to define zoned areas within the facility. Zoned areas can, for example, define areas including input and output devices, as discussed in more detail below.

Once the zoning is configured, the C&E rules can be automatically assigned to the devices in the newly defined zone. The use of automatic zone organization based on the communication via the communication components in the detection devices (for self-testing) allows for quick set up of the devices of the zone. This automated approach also lowers the risk that a device is missed during commissioning or put in the wrong zone. However, in some embodiments, the combination with a manual review can further reduce these issues and can verify that the output device(s) assigned to the zone are correctly assigned.

Further, the modified floorplan and zoning data 220 can be provided to the emergency responder or technician performing maintenance 211 (e.g., via the gateway 210 and/or cloud server 218). In this manner, the emergency responder or technician performing maintenance 211 can have enhanced zoning tools available to them as they traverse through the facility, which may be beneficial for navigation.

The floorplan information and location information of the event detection devices can be derived from building information model (BIM) files stored in memory. For example, a remote server can include a memory wherein floorplans of each floor of the building are stored therein and wherein the computing device accesses the floorplans and uses data from the floorplans to create the visual floor representation. Once updated with the configured zone locations, the visual floor representation is transmitted to the remote server from the first computing device, for example, the information can be transmitted to the first computing device through a gateway device.

In various embodiments where self-test event detector devices are installed in the facility for event detection and an on-premises workstation software is provided on an on-premises computing device (e.g., Honeywell's Cloud Connected Horizon (CCH)) software that is part of an event alarm system network at the facility, a gateway device can also be installed and interconnected to the control panel, on-premises computing device, and/or control software on a portable device. Using such an arrangement, the system can be configured as follows.

The control panel is installed along with self-test detection devices and connections to the SLC. Once commissioned, the system is maintained in a system normal condition where the system monitors for detection of events detected by the detection devices.

A technician (e.g., commissioning engineer) connects the gateway between the control panel network and the on-premises computing device as a single network. This control panel network and its respective self-test detection devices are then discovered via the workstation software and populated in the on-premises computing device via the gateway. The commissioning engineer imports the as built floor plan of the Site/Building (e.g., a JPEG image, could be from a BIM file) for each floor into the on-premises computing device.

Each detection device(s) populated above are dragged and dropped in the floor plan illustration to match their real-world location co-ordinates as each populated detection device is physically located on the floor. Such a configuration process can include detector devices, input components, pull stations, output components, strobes, sounders, panic door alarms, and/or other alarm system components.

The on-premises computing device graphics are commissioned such that when a detection device detects an event; the respective device icon on the on-premises computing device flashes to indicate the device is actively reporting an event.

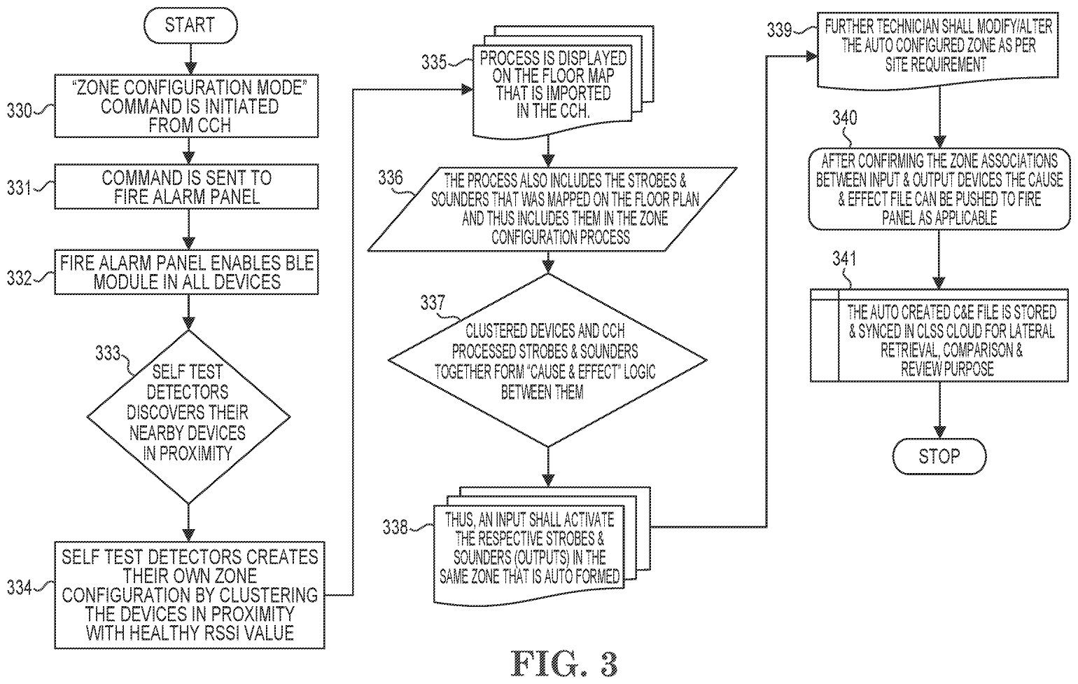

Utilizing embodiments of the present disclosure, the technician can initiate a command to deploy a “Zone Configuration Mode” from the on-premises computing device and an instruction is sent to the control panel via gateway. This initiates a configuration process described in FIG. 3.

FIG. 3 is a commissioning flow example of an event alarm system in accordance with one or more embodiments of the present disclosure. The flow begins in the upper left with the initiation of the zone configuration mode is indicated at 330. The control panel processes the instruction via its processor to activate all the connected self-test detection device's short range communication components (e.g., Bluetooth low energy (BLE) modules) that are inbuilt in each self-test detection device, at 331 and 332.

The self-test detection devices discover their nearby devices (e.g., adjacent, within short range communication range, etc.) which are in proximity using a short range communication beacon functionality, which sends a signal periodically which can be identified by other detection devices, at 333. The self-test detection devices each creates its own zone configuration by clustering the devices which are in a threshold proximity (e.g., adjacent, within short range communication range, with a received signal strength indicator (RSSI) decibel milliwatt (dBm) value within a threshold value) at the detection device carrying out the analysis, at 334.

In some embodiments, the process can be displayed in a visual floor representation that can be imported to the on-premises computing device, at 335. This graphical depiction of the visual floor representation can include an illustration of auto created zones (created via computing device executable instructions) with differentiated margins and/or boundaries drawn virtually to indicate where a cluster of devices is formed, what detection devices are in each cluster, and how the detection device clusters are positioned and oriented with respect to each other and with respect to the layout of walls/hallway/rooms.

In various embodiments, computing device executable instructions also involve and interpret the strobe and/or sounder icons that are mapped on the visual floor representation and thus the software includes them in the zone configuration process, at 336. In this process, for example, they can be positioned in the visual floor representation and grouped with a cluster whose boundaries surround it.

All clustered detection devices, and strobe and sounder icons depicted on the visual floor representation create a “Cause & Effect” logical cluster including them, where particular cause rules initiate particular effects (e.g., emergency event detected—event alert initiated), at 337. Accordingly, in some such embodiments, the software can define a cluster/zone where any input from the auto formed zone can cause C&E rules, preselected by the operator of the system, to activate the respective strobe(s), sounder(s), and or other output(s) in the same zone as the detection device detecting an event, at 338. In this manner, the C&E rules can be selected once and they can be applied to all devices of the cluster, either during commissioning of the whole alarm system or a new detection device.

In various embodiments, the technician can take make overwrite decisions via computing device executable instructions (modify, alter, include, exclude, delete, add device, remove device, and/or etc.) to the auto configured zone for betterment of the site requirement or to more accurately depict the physically natural zoning of the floor's layout, at 339. For example, after autoconfiguring and confirming the zone/cluster associations between input (e.g., detection devices) and output devices (e.g., strobe, sounder) the technician can download/transfer the data file to the control panel, at 340. When such a zone is formed using short range communication proximity in event detection devices, the control panel can automatically assign preselected operational settings of that zone. Such operational settings can, for example, be preselected by the Operator/Technician and can include configuring cause and effect rules for each of the zones. These operational zones settings can be saved for later retrieval, comparison, and review and can be used to quickly configure new and/or replacement devices to a particular zone, at 341.

FIG. 4 is an example of an event alarm system having multiple alarm system event detection devices having communication components organized in areas of a facility and communicating to establish one or more zones in accordance with one or more embodiments of the present disclosure. FIG. 4 represents a visual floor representation, here, the floorplan of building #1, floor #4.

In this example, the floor includes multiple spaces. These spaces can be defined by walls or can be portions of larger spaces within the facility. The floorplan also includes a number of doors or walkways allowing movement between spaces. Additionally, the floorplan includes the locations of multiple event detection devices 406 that correspond to their physical location in these spaces of the floor.

In FIG. 4, the floor includes spaces 422, 423, 424, 426, 427, 428, and 429. Within area 424 is zone 5 at 442 defined by multiple (here, 4) detection devices that self-defined a zone based on communication with each other to create zone 5. The self-configured zones are indicated by zone numbers 1-6 and are defined by boundary lines around each zone. As discussed herein, once the discovery process is initiated, the devices communicate with each other to define which zones each detection device belongs and then is assigned to that created zone.

Also shown in zone 5 is a non-communication equipped system device 425 (e.g., a sounder) that will provide an output to the zone occupants and potentially those outside the zone, such as an audible and/or visual signal. In some embodiments, a technician can review the created zones and correct any incorrect auto assignments and non-communication equipped system devices within the zone. C&E rules can then include the functions of these non-communication equipped system devices (e.g., sounding a non-communication equipped system device within zone 5 when a detection device 406 within zone 5 detects an event).

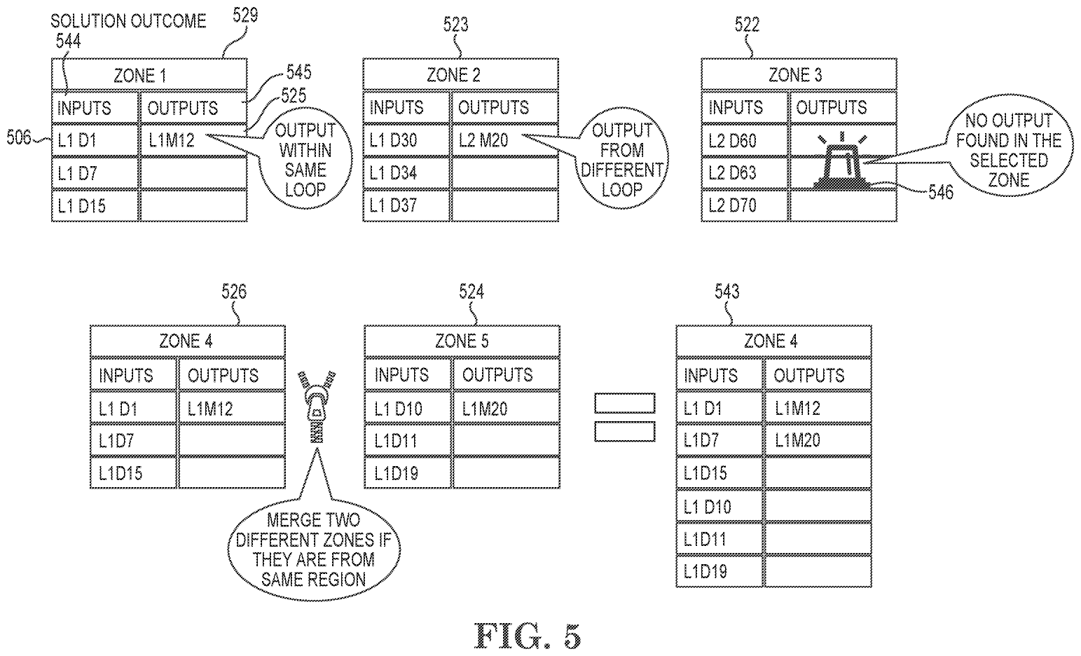

FIG. 5 is an example of a system input and output device grouping structure of an event alarm system in accordance with one or more embodiments of the present disclosure. FIG. 5 is a depiction of a review system for a technician to review the auto created zone arrangement created by the interaction between the detection devices and the zone configuration software used to manage the zone creation process.

Here, zones 1-5 (529, 523, 522, 526, and 524) are shown each having a number of inputs 544, e.g., input devices 506 (detection devices) and a number of outputs 545, e.g., output devices (e.g., audible and/or visual devices) 545. Through use of such review software, a technician can find devices that are assigned to the wrong zone and/or provide an indication where no output device is assigned to a zone 546.

The zone configuration software can also include a merge function wherein the technician can select multiple auto defined zones and merge them together to create a merged zone. For example, in FIG. 5, zones 4 and 5 526 and 524 are merged into a merged zone 543.

Through use of the embodiments of the present disclosure, a zoned alarm system can be created more quickly and accurately than the processes used to create such systems in the past. This is due, in part, to detection devices having communication capabilities and zone configuration software that facilitates the detection devices in determining their own zones.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method, comprising:
initiating a zone configuration software by sending computing device executable instructions to a control panel of an alarm system;
sending, via the control panel, instructions, to each event detection device of the alarm system, to initiate short range communication to detection devices within each device's communication range;
receiving detection device identification information that identifies each detection device within a particular device's communication range;
determining and creating a zone by clustering detection devices with a communication signal strength above a threshold strength value.

2. The method of claim 1, wherein the method further includes creating a visual floor representation, including an indication of a specific location of the created zone on a display of the portable device.

3. The method of claim 1, wherein the visual floor representation is transmitted to the remote server from the computing device.

4. The method of claim 1, wherein the short range communication functionality is Bluetooth low energy.

5. The method of claim 1, wherein the method further includes determining physical locations for each of the event detection devices on a floor and positioning device indicators in locations on the visual floor representation corresponding to each event detection device's physical location.

6. The method of claim 1, wherein the information is transmitted to the computing device through a gateway device.

7. The method of claim 1, further comprising, assigning a non-communication equipped system device to the created zone.

8. The method of claim 7, automatically assigning the set of cause and effect rules to all detection devices and non-communication equipped system devices of the created zone.

9. The method of claim 1, determining a set of cause and effect rules for the created zone.

10. The method of claim 1, automatically assigning the set of cause and effect rules to all detection devices of the created zone.

11. A system, comprising:
a number of event detection devices configured to detect an event within a building; and
an alarm system control panel configured to receive information about the event or event detection devices and transmit the information to a computing device;
wherein the computing device is configured to:
initiate a zone configuration software by sending computing device executable instructions to a control panel of an alarm system;
send, via the control panel, instructions, to each event detection device of the alarm system, to initiate short range communication to detection devices within each device's communication range;
receive detection device identification information that identifies each detection device within a particular device's communication range;
determine and creating a zone by clustering detection devices with a communication signal strength above a threshold strength value.

12. The system of claim 11, wherein computing device assigns the set of cause and effect rules to a new device automatically when the device is assigned to the zone.

13. The system of claim 11, wherein the computing device is a portable computing device that is remotely connected to the alarm system.

14. The system of claim 11, wherein the computing device is a portable computing device that is remotely connected to the alarm system via the gateway device.

15. The system of claim 11, wherein a remote server includes a memory wherein floorplans of each floor of the building are stored therein and wherein the computing device accesses the floorplans and uses data from the floorplans to create the visual floor representation.

16. A method, comprising:
initiating a zone configuration software by sending computing device executable instructions to a control panel of an alarm system;
sending, via the control panel, instructions, to each event detection device of the alarm system, to initiate short range communication to detection devices within each device's communication range;
receiving detection device identification information that identifies each detection device within a particular device's communication range;
determining and creating a zone by clustering detection devices with a communication signal strength above a threshold strength value;
accessing floorplan data and using the data from the floorplans to create the visual floor representation including an illustration of the created zone.

17. The method of claim 16, wherein the method further includes creating a visual floor representation, including an indication of multiple created zones and their boundaries with respect to each other on a display of the portable device.

18. The method of claim 16, wherein the method further includes determining physical locations for each of the event detection devices on a floor and positioning device indicators in locations on the visual floor representation corresponding to each event detection device's physical location.

19. The method of claim 16, further comprising including at least one non-communication equipped system device within the created zone.

20. The method of claim 16, further comprising, defining a set of cause and effect rules that defines a particular cause from an input detection device of the created zone and an output non-communication equipped system device of the created zone.
